(19) United States
(12) Patent Application Publication
(10) Pub. No.: US 2007/0005372 A1
(43) Pub. Date: Jan. 4, 2007

(54) Process and device for confirming and/or correction of a speech input supplied to a speech recognition system

(75) Inventors: Harald Huning, Blaustein (DE); Susanne Kronenberg, Ulm (DE); Michael Munz, Ulm (DE)

Correspondence Address: AKERMAN SENTERFITT, P.O. BOX 3188, WEST PALM BEACH, FL, 33402-3188, US

(73) Assignee: DaimlerChrysler AG

(21) Appl. No.: 11/478,809

(22) Filed: Jun. 30, 2006

(30) Foreign Application Priority Data
Jun. 30, 2005 (DE) 102005030963.1-42

(51) Int. Cl. G10L 21/00

(52) U.S. Cl. 704/275

(57) ABSTRACT

In the case of vary large vocabulary, such as for example a list with all cities in Germany, there is the problem, that the addition of other words, which are activated parallel to this list during recognition, leads to a higher danger of a mix-up. If the recognition result cannot be associated with sufficient confidence with an element from a vocabulary list, then the user of the system is presented with the recognition result for confirmation thereof. Prior to the presentation of the system user with the recognition result a temporary vocabulary is formed, in which first that element is removed from the vocabulary list, of which the correct recognition is to be confirmed by the user. The recognizer processes this speech input on the basis of the temporary vocabulary as well as on the basis of the system commands and selects therefrom as recognition result at least one element. The recognition result is then checked with regard to whether the speech pattern is evaluated with greater probability as element of the system commands than as temporary vocabulary. If this is the case, then it is consequentially interpreted by the speech recognition system as system command.

### BACKGROUND OF THE INVENTION

1. Field of the Invention

The invention concerns a process and a device for confirming and/or correcting a speech input supplied to a speech recognition system.

2. Description of Related Art

If one would like to allow a speech recognition system to reliably recognize words from a larger vocabulary together with system commands within the same expression, it is known that, if a word cannot be associated with sufficient probability with an entry in the vocabulary or with a system command, the system user is requested to verify the input. In the confirmation of city names it is desirable for future systems that an incorrectly recognized name is corrected in that the name offered for confirmation is responded to in the negative and the correct name is simultaneously presented in a speech expression. If the system recognized, for example, “Homburg” instead of “Hamburg” and asked the system user for a confirmation of this city name, then a probable answer by the user would be “No, Hamburg”. A problem therein is that frequently the new recognition product resulting there from is subject to the same error as before.

In a very large vocabulary, such as for example a list of names of all cities in Germany, there is the problem that the addition of other words, for which recognition is activated parallel to this list, leads to a higher probability of a mix-up. This means, that supplemental commands, which are active in parallel, are often confused with city names. The recognition of larger vocabularies is particularly difficult with large dynamic loaded lists; these lists could be either static lists such as city names or also dynamic lists such as text or voice enrollments. It is here difficult to define in advance what size of resources the speech recognition system must have allocated to it in order to be able to evaluate sufficient numbers of alternatives in the case of similar words.

There is further the problem, in a system known from the state of the art, that frequently either only the list of text enrollments (for example: city names) or as the case may be voice enrollments, or the system commands associated therewith dedicated to the speech recognition system, is active, so that it is not possible to speak in a single expression commands as well as text enrollments or as the case may be voice enrollments. This corresponds however not to the natural behavior of a system user, since he is accustomed, upon being requested to confirm a questionably recognized text enrollment or as the case may be voice enrollment, to simultaneously negate the recognition result and to speak the text enrollment or as the case may be voice enrollment which is intended to be recognized as correct.

From U.S. Pat. No. 5,231,670 A1 a speech recognition system is known, in which a spoken signal is divided into system commands and text elements. Herein a system command is an action to be carried out by the system and which, within the spoken signal, is usually spoken after the text element so that the action is to be applied to this text. For this, it is proposed to separate the information contained in the command and the text elements, and to supply these to a recognizer and process these independently of each other. In this manner, it becomes easier for the speech recognizer to associate the system commands or, as the case may be, text elements contained in the spoken signal, more clearly to elements of the respective word lists. On which basis the command and text elements are to be identified within the speech signal prior to their separation is however not disclosed.

One process for identification of command and text elements in speech signals is described in European Patent EP 0 785 540 B1. For distinguishing, it is proposed to examine the individual elements of the speech signal for the presence of a structure typical for command elements or text elements. In particular, it is proposed to observe the duration of speech pauses prior to or subsequent to the individual elements, wherein it is presumed, that the presence of a command element can be concluded if a significant pause in speech is noted prior to and/or subsequent to the element.

### SUMMARY OF THE INVENTION

It is the task of the invention to provide a new type of process and a new type of device for confirming and/or correcting a speech input supplied to a speech recognition system, which makes it possible reliably to confirm or correct a recognized error by means of a new speech input.

The task is solved by a process and a device with the characteristics set forth in the claims.

In the system for confirming a speech input supplied to a speech recognition system, it is checked whether the recognizer of the speech recognition system can with sufficient confidence associate the speech input with an element from one of the lists associated with the system. This type of list could be a static list such as city names or however could also be a dynamic list, in particular text or voice enrollments; for ease of explanation of the invention in the following reference will be made to this type of list only by the single term “vocabulary list”. If the speech input cannot with sufficient confidence be associated with an element from the vocabulary list, then the user of the system is confronted with the recognition result for confirmation thereof. Herein the confirmation by the user occurs in the framework of a new speech input. For this, it is of course without consequence for the inventive process whether a speech input occurs by speaking of speech information into a microphone, or whether the speech recognition system is supplied the speech information in another manner by a suitably designed interface. In the inventive manner, prior to the confrontation of the system user with the recognition result for the confirmation or correction thereof, a temporary vocabulary is formed, in which preliminarily that respective element is removed from the vocabulary list, of which the correct recognition is to be confirmed by the user. The input subsequently following for confirmation or correction of a speech signal is then process by a recognizer on the basis of both this temporary vocabulary as well as the system command. As recognition result, there is then selected at least one element from the temporary vocabulary or from the system commands. The recognition result is then checked with respect to whether the speech pattern is with higher probability an element of the system command than an element of the temporary vocabulary. If this is the case, then it is consequently appropriately interpreted by the speech recognition system as system command. In the other case, the speech pattern is interpreted as the selection of an element from the vocabulary list.

In a particularly advantageous embodiment of the invention the speech signal input for confirmation or correction is intermediate stored in a memory. The recognizer first processes the input speech signal solely on the basis of the previously generated temporary vocabulary and selects as recognition result at least one element from this temporary vocabulary. Subsequently then the immediate stored speech input is renewed supplied to the recognizer, whereupon the recognizer processes this in its recognition process solely on the basis of the previously selected at least one element of the temporary vocabulary and the system command. As already described in the framework of the alternative embodiment of the invention, the recognition result is now checked, with regard to whether the speech pattern is recognized with higher probability as an element of the system command than as the at least one selected element of the vocabulary list. If this is the case, then it is appropriately interpreted in due course by the speech recognition system as system command. In the other case, the speech pattern is interpreted as selection of this element from the vocabulary list.

In inventive manner the recognizer works, after the invitation to confirm the recognition result, on the basis of the vocabulary list from which however the insufficiently recognized list element had been temporarily removed. Thereby it is ensured, that the same recognition result is not again repeated. Thereby, that also in the confirmation of the recognition occurs on the basis of the in general very large vocabulary list, therewith naturally also a word will be recognized from this vocabulary list, even if the user has only expressed “Yes”. In order to avoid this, the new recognition process is carried out on the basis of the vocabulary list reduced by the insufficiently recognized list element and supplementally the system command. If then in this second running by the recognizer a system command is returned, then the dialog can presume, that the expression previously spoken by the user is a system command.

### BRIEF DESCRIPTION OF THE DRAWINGS

In the following the invention will be described in greater detail on the basis of the Figures.

FIG. 1 schematically shows the sequence diagram of the speech recognition in the case that the user is requested to confirm or correct his speech input.

FIG. 2 schematically shows an alternative process sequence, which indicates an increased measure of distinguishing capability between the input of elements of the vocabulary list and system commands.

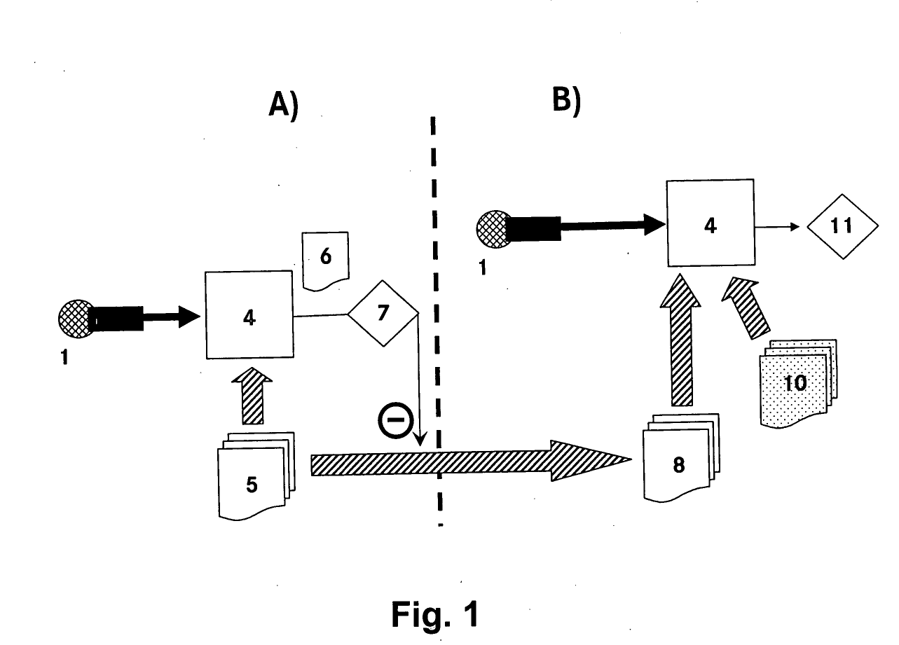

In the flow diagram shown in FIG. 1 there is illustrated the confirmation and correction process in two steps A) and B). In Step A) the first speech input by the system user via the microphone 1 takes place. The speech recognition system supplies the speech signal to the recognizer 4. The recognizer processes on the basis of the vocabulary list 5 associated with it, which contains the elements to be recognized in the framework of the speech recognition. The recognizer 4 supplies as recognition result 6 one element of the vocabulary list 5. The recognition result 6 is then checked in a checking unit 7 with respect to whether the recognition result 6 can associate with sufficient confidence the speech input of the system user with an element from the vocabulary list 5. If this is not the case, then the vocabulary list 5 is mapped to a new temporary vocabulary 8 which is formed by removing from the vocabulary list 5 the element 6 supplied as recognition result by the recognizer 4.

After forming the temporary recognition vocabulary 8 the second process step B) is initiated. B) serves for confirmation or correction of the list element 6 supplied as recognition result in step A) by the recognizer 4. The system user is asked to confirm the recognition result by speech input in the microphone 1. The speech signal supplied to the speech recognition system in step B) is, on the one hand, intermediate stored in memory 3 and, on the other hand, supplied to the recognizer 4. The recognizer processes on the basis of a combination of the temporary vocabulary 8 and the system command 10. As recognition result 11 the recognizer 4 supplies now at least one element from the temporary vocabulary 8. Of course, the recognizer can also be so designed that it produces as result 11 multiple entries from the vocabulary list 8. For this, it is conceivable in an advantageous manner to so design the recognizer that, to make possible a better determination of quality, a probability value, and particular a confidence value, is associated with the individual recognition results. With the aide of this probability or confidence then, with suitable processes known from the state-of-the-art, an evaluation of the recognition result can occur. Beginning with the evaluation of the recognition results 11, in the case that the speech pattern was recognized with higher probability as element of the system command 10 than as element of the temporary vocabulary 8, it is consequently interpreted by the speech recognition system as system command. If however, a selection is made with higher probability of an element from the temporary vocabulary 8, then it is assumed, that the corresponding text enrollment represents the originally desired selection of a list element from the vocabulary list 5, which corrects the erroneous recognition result from process A).

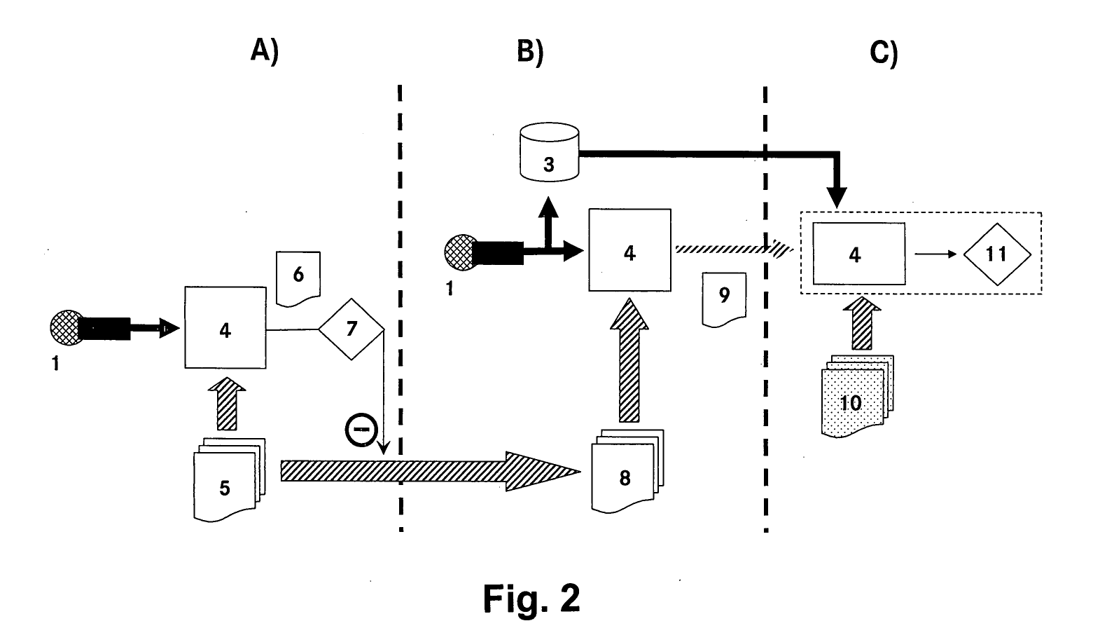

In the alternative embodiment represented in FIG. 2 of the invention, the process step A) runs identically to that already described for FIG. 1, so that here reference can be made to the description of step A) in the previous paragraphs. The further process step B), which serves for confirmation or correction of the list element 6 supplied as recognition result in step A), is modified in this alternative embodiment of the invention and expanded by a supplemental recognition step C). The speech signal newly supplied in step B) to the speech recognition system via a microphone 1 is intermediate stored in a memory 3. The recognizer 4 processes in process step 4 only on the basis of the temporary vocabulary 8, which was produced by removal of the element 6 supplied as the recognition result from the vocabulary list 5. Beginning with the new speech input in step B) the recognizer 4 supplies as result 9 at least one element from the temporary vocabulary 8. Also in this running of the recognizer 4 it is of course conceivable, that this supplies multiple alternative recognition results 9, which on the basis of the probabilities associated therewith, in particular confidence values, can be subject to a qualitative evaluation and selection.

In a supplemental recognition step C) the speech signal stored intermediate in the memory 3 is supplied to the recognizer 4 for recognition. In this new recognition process the recognizer 4 works on the basis of both the element 9 supplied as a result by the preceding recognition process as well as on the basis of the system commands 10. The recognizer supplies as result 11 at its out put at least one element either from the system commands or from the result 9 of the preceding running of the recognizer. On the basis of the result 11 it is thereafter determined, as to whether in step B) the speech pattern spoken into the microphone represents an element of the preceding recognition result 9 or an element of the system command 10. Beginning with this determination it is then, if the speech pattern is recognized with higher probability as element of the system command 10, correspondingly interpreted by the speech recognition system as system command. If however it is decided with higher probability to be an element of the recognition result 9, then based on the presumption, that correspondingly a desired selection from the temporary vocabulary 8 is present, it corrects the erroneous recognition and selection of the element from the vocabulary list 5 in process step A).

1. A process for confirming or correcting a speech input supplied to a speech recognition system comprising a recognizer and a list, in which it is checked, whether the recognizer of the speech recognition system can associate the speech input with an element from the list (vocabulary list) associated with the system as recognition result with sufficient confidence, comprising:
determining the level of confidence of the association of the speech input with the element from the vocabulary list and, if this association does not exhibit a sufficient level of confidence, presenting the system user with the recognition result for the confirmation or correction thereof, and
supplying a new speech input for the confirmation or correction, wherein
prior to the presentation of the user with the recognition result, a temporary vocabulary (8) is formed, in which that element is removed from the vocabulary list (5), of which the user is invited to confirm the correctness if the recognition,
the recognizer (4) processes the new speech input on the basis of the temporary vocabulary (8) and on the basis of the system commands (10), and selects therefrom as recognition result (11) at least one of the elements either from the temporary vocabulary (8) or from the system commands (10),
then, when the recognition result (11) is recognized with greater probability as element of the system command (10) than as element of the temporary vocabulary (8), it is interpreted in consequence by the speech recognition system accordingly as system command,
and wherein then, when thereby the speech pattern was recognized with greater probability as element of the temporary vocabulary (8), the speech pattern is interpreted as correction of the original speech input.

2. A process for confirming or correcting a speech input supplied to a speech recognition system comprising a recognizer and a list, in which it is checked, whether the recognizer of the speech recognition system can associate the speech input with an element from the list (vocabulary list) associated with the system as recognition result with sufficient confidence, comprising:
determining the level of confidence of the association of the speech input with the element from the vocabulary list and, if this association does not exhibit a sufficient level of confidence, presenting the system user with the recognition result for the confirmation or correction thereof, and
supplying a new speech input for the confirmation or correction, wherein
prior to the presentation of the user with the recognition result, a temporary vocabulary (8) is formed, in which that element is removed from the vocabulary list (5), of which the user is invited to confirm the correctness if the recognition,
the speech input to be confirmed is intermediate stored in a memory (3),
the recognizer processes this speech input on the basis of the temporary vocabulary (8) and therefrom selects as recognition result (9) at least one of the elements of the temporary vocabulary (8),
subsequently this at least one element (9) together with the system commands (10) is the basis of the next recognition process,
for the next recognition process the intermediate stored speech input is provided to the recognizer (4),
then, when the new recognition result (11) is recognized with greater probability as element of the system command (10) than as element of the recognition result (9), it is consequently interpreted by the speech recognition system as system command,
and wherein then, when thereby the speech pattern is recognized with greater probability as element of the recognition result (9), the speech pattern is interpreted as a correction of the original speech input.

3. A process according to claim 1 wherein the recognizer (4) provides multiple alternative list elements as recognition result (6, 9, 11).

4. A process according to claim 1 wherein for quality determination the recognizer provides probabilities, in particular confidence values, for the qualitative evaluation of a recognition result (6, 9, 11).

5. A process according to claim 1, wherein the speech pattern is supplied to the speech recognition system by speaking into a microphone (1).

6. A device for confirming or correcting a speech input supplied to a speech recognition system, comprising:
an input means (1) input of a speech signal,
a unit (7) by means of which it can be checked whether the recognizer (4) of the speech recognition system can, with sufficient confidence, associate the speech input with an element from a list (5) of text enrollments associated with the system as recognition result (6),
means for presenting the user, when this association does not exhibit a sufficient confidence, with the recognition result for confirmation or correction thereof,
means for processing a new input of a speech signal in the input means (1) via which the user confirms or corrects the recognition result (6),
a means which produces a temporary vocabulary (8) prior to the confrontation of the user with the recognition result, in which that element (6) which the user is to confirm the recognition of or correct is removed from the vocabulary list (5),
wherein the recognizer (4) is so designed, that the new speech input occurs both on the basis of the temporary vocabulary as well as on the basis of the system commands.

7. A device according to claim 6, including a memory (6) for intermediate storage of the speech signal input for confirmation or correction.

8. A process according to claim 2, wherein the recognizer (4) provides multiple alternative list elements as recognition result (6, 9, 11).

9. A process according to claim 2, wherein for quality determination the recognizer provides probabilities, in particular confidence values, for the qualitative evaluation of a recognition result (6, 9, 11).
